(19) United States
(12) Patent Application Publication
(10) Pub. No.: US 2013/0275269 A1
(43) Pub. Date: Oct. 17, 2013

(54) SEARCHING SUPPLIER INFORMATION BASED ON TRANSACTION PLATFORM

(71) Applicant: ALIBABA GROUP HOLDING LIMITED, Grand Cayman (KY)

(72) Inventors: Zhiqiang Chen, Hangzhou (CN); Xu Chen, Hangzhou (CN); Haijie Gu, Hangzhou (CN); Liang He, Hangzhou (CN); Desheng Wang, Hangzhou (CN)

(73) Assignee: Alibaba Group Holding Limited, Grand Cayman (KY)

(21) Appl. No.: 13/859,919

(22) Filed: Apr. 10, 2013

(30) Foreign Application Priority Data
Apr. 11, 2012 (CN) 201210105607.7

(51) Int. Cl. G06Q 30/06

(52) U.S. Cl. CPC G06Q 30/0625
USPC 705/26.62

(57) ABSTRACT

The present disclosure provides a method and an apparatus for searching supplier information based on a transaction platform. Each supplier may have one or more product group information and each of the product group information may have its corresponding characteristic weighted parameter. A search request for one or more supplier submitted by a user is received. The search request includes one or more search keywords. A preset supplier information database is searched to find product group information of the suppliers that matches the search keywords. A weighted result of respective matched product group information of a respective supplier is obtained according to its respective characteristic weighted parameter. The weighted product group information of the suppliers is ranked and corresponding supplier information is returned to the user. The present techniques may provide individualized searching functionalities to a buyer and enable the buyer to efficiently and simply find a best supplier.

### CROSS REFERENCE TO RELATED PATENT APPLICATIONS

This application claims foreign priority to Chinese Patent Application No. 201210105607.7 filed on 11 Apr. 2012, entitled “Method and Apparatus for Searching Supplier Information Based on Transaction Platform,” which is hereby incorporated by reference in its entirety.

### TECHNICAL FIELD

The present disclosure relates to the field of transaction platform data processing and, more specifically, to a method and an apparatus for searching supplier information based on transaction platform.

### BACKGROUND

Under the open environment at the Internet, based on network communication technologies, buyers and sellers can conduct commercial activities through a transaction platform, such as online shopping, online transaction between merchants, online payment, and various business activities, transaction activities, financial activities and other related comprehensive services. Currently, the transaction platform is generally divided into Business-to-Business (B2B), Business-to-Customer (B2C), and Customer-to-Customer (C2C) models. In recent years, the transaction platform has grown rapidly. Many B2B, C2C, B2C transaction platforms (or shopping websites), such as Taobao™, Dangdang™, and Amazon™, have been widely recognized and accepted by users.

At an e-commerce transaction platform, a seller may publish his/her supplied product information or category information from his/her webpage. If there are many types of numerous products, the seller may categorize the products according to certain rules. To provide a direct and intuitive impression to a buyer for his/her convenience of viewing, the seller may set display window information to directly display images, titles, and other information of the products at the front page of his/her webpage.

When the buyer purchases the products, the buyer may conduct a transaction by selecting and filtering satisfactory suppliers at the transaction platform. Under conventional techniques, after obtaining the identifications of the suppliers, the buyer can search to obtain information of the products supplied by corresponding suppliers based on the identifications of the suppliers. However, in most circumstances, the buyer can only use his/her self-defined inquiry word to search his/her interested products at the transaction platform, use the product information to find the information of the corresponding supplier, and obtain relevant information of the products supplied by the supplier. In addition, the found suppliers through such conventional techniques very often are not the best suppliers and require further manual filtering.

Therefore, a new supplier information searching technique based on the transaction platform is in desperate need to provide individualized searching functionality to the buyer and enable the buyer to promptly and easily find the best suppliers.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to apparatus(s), system(s), method(s) and/or computer-readable instructions as permitted by the context above and throughout the present disclosure.

The present disclosure provides a method for searching supplier information based on transaction platform. A supplier has one or more product group information. Each of the product group information has its corresponding characteristic weighted parameter.

A search request for one or more suppliers submitted by a user is received. The search request includes one or more search keywords. A preset supplier information database is searched to find product group information of the suppliers that match the search keywords. A weighted result of respective matched product group information of a respective supplier is obtained according to its respective characteristic weighted parameter. The weighted product group information of the suppliers is ranked and corresponding supplier information is returned to the user.

For example, the characteristic weighted parameter may include a primary business coefficient. The characteristic weighted parameter of respective product group information of a respective supplier may be obtained as follows. A first percentage and a second percentage are calculated. The first percentage represents a percentage of a number of products in a respective product group of the respective supplier to a total number of products of the respective supplier. The second percentage represents a number of products with characteristic identifications in the respective product group of the respective supplier to a total number of products with the characteristic identification of the respective supplier. A first weight of the first percentage and a second weight of the second percentage are used for a weighted calculation. The second weight may be higher than the first weight. The weighted first percentage and the weighted second percentage are combined to obtain the primary business coefficient of the respective product group of the respective supplier. The characteristic identifications may include a display recommendation identification.

For example, the preset supplier information database may include one or more supplier information keywords and one or more supplier information phrase lists corresponding to the respective product group information of the respective supplier. The supplier information keywords may include one or more title keywords. The title keyword may be obtained through obtaining the product title information of the product groups of the suppliers and word-segmenting the product title information. The supplier information phrase list may be obtained through obtaining the product title information of the product groups of the suppliers and phrase-segmenting the product title information.

For another example, the supplier information keywords may also include one or more product group keywords. The product group keywords may be obtained by obtaining a respective product group name of the respective supplier and segmenting the respective product group name of the respective supplier.

For another example, the supplier information keywords may also include one or more category keywords. The category keywords may be obtained by obtaining respective category information of the respective product of the respective supplier and extracting the category keywords from the respective category information. The respective category information may include description information of a root category and description information of a leaf category.

For another example, the supplier information keywords may also include one or more attribute keywords. The attribute keywords may be obtained by obtaining attribute information of the respective product of the respective supplier and extracted from the category attribute information.

For another example, the search keywords may include one or more words and/or phrases. The preset supplier information database is searched to find product group information of the suppliers that match the search keywords by the following operations. The phrases are used to search the supplier information phrase list to extract a number of K most similarly matched product group information of the suppliers as matched product group information of the suppliers. K represents a preset number threshold. If the number of found product group information of the suppliers based on the phrases is L and L<K, the words are further used to search the supplier information keywords and a number of K-L most similarly matched product information of the suppliers are extracted. The L product group information of the suppliers and the K-L product group together compose the matched product group information of the suppliers.

For another example, the search keywords may include one or more words and/or phrases. The preset supplier information database is searched to find product group information of the suppliers that match the search keywords by the following operations. The phrases are used to search the supplier information phrase list to extract a number of K most similarly matched product group information of the suppliers as candidate product group information of the suppliers. K represents a preset number threshold. If the number of found product group information of the suppliers based on the phrases is L and L<K, the words are further used to search the supplier information keywords and a number of K-L most similarly matched product information of the suppliers are extracted. The L product group information of the suppliers and the K-L product group together compose candidate product group information of the suppliers. A first text similarity degree and a second text similarity degree are calculated. The first text similarity degree represents a text similarity degree between the words of the search keywords and the supplier information keywords of the candidate product group information of the suppliers. The second text similarity degree represents a text similarity degree between the phrases of the search keywords and the supplier information phrase list of the candidate product group information of the suppliers. A preset number of the candidate product group information of the suppliers are selected, according to a descending order of the first text similarity degree and the second text similarity degree, as the matched product group information of the suppliers.

The present disclosure also provides an apparatus for searching supplier information based on transaction platform. A supplier has one or more product group information. Each of the product group information has its corresponding characteristic weighted parameter. The apparatus may include a request receiving module, a searching module, a weighting module, and a returning module.

The request receiving module receives a search request for one or more suppliers submitted by a user. The search request includes one or more search keywords. The searching module searches a preset supplier information database to find matched product group information of the suppliers according to the search keywords. The weighting module calculates or assigns weights to the matched product group information of the suppliers according to their respective characteristic weighted parameters. The returning module ranks the weighted product group information of the suppliers and returns corresponding supplier information to the user.

For example, the characteristic weighted parameter may include a primary business coefficient. The characteristic weighted parameter of respective product group information of a respective supplier may be obtained as follows. A first percentage and a second percentage are calculated. The first percentage represents a percentage of a number of products in a respective product group of the respective supplier to a total number of products of the respective supplier. The second percentage represents a number of products with characteristic identifications in the respective group of the respective supplier to a total number of products with the characteristic identification of the respective supplier. A first weight of the first percentage and a second weight of the second percentage are used for weighted calculation. The second weight may be higher than the first weight. The weighted first percentage and the weighted second percentage are combined to obtain the primary business coefficient of the respective product group of the respective supplier. The characteristic identifications may include a display recommendation identification.

For example, the preset supplier information database may include one or more supplier information keywords and a supplier information phrase list corresponding to the respective product group information of the respective supplier. The supplier information keywords may include one or more title keywords. The title keyword may be obtained by obtaining respective product title information of the respective product group of the respective supplier and segmenting the respective product title information.

For another example, the supplier information keywords may also include one or more product group keywords. The product group keywords may be obtained by obtaining a respective product group name of the respective supplier and segmenting the respective product group name of the respective supplier.

For another example, the supplier information keywords may also include one or more category keywords. The category keywords may be obtained by obtaining respective category information of the respective product of the respective supplier and extracting the category keywords from the respective category information. The respective category information may include description information of a root category and description information of a leaf category.

For another example, the supplier information keywords may also include one or more attribute keywords. The attribute keywords may be obtained by obtaining attribute information of the respective product of the respective supplier and extracted from the category attribute information.

For another example, the search keywords may include one or more words and/or phrases. The searching module may include a first extracting sub-module and a second extracting sub-module. The first extracting sub-module searches the preset supplier information database by using the phrases to extract a number of K most similarly matched product group information of the suppliers as matched product group information of the suppliers. K represents a preset number threshold. If the number of found product group information of the suppliers based on the phrases is L and L<K, the second extracting sub-module further uses the words to search the supplier information keywords and extracts a number of K-L most similarly matched product information of suppliers. The L supplier group information and the K-L product group compose the matched product group information of the suppliers.

For another example, the search keywords may include one or more words and/or phrases. The searching module may include a first candidate information extracting sub-module, a second candidate information extracting sub-module, a first text similarity degree calculating module, a second text similarity calculating module, and an information selecting sub-module. The first candidate information extracting sub-module searches the preset supplier information database by using the phrases to extract a number of K most similarly matched product group information of the suppliers as candidate product group information of the suppliers. K represents a preset number threshold. If the number of found product group information of the suppliers based on the phrases is L and L<K, the second candidate information extracting sub-module further uses the words to search the supplier information keywords and extracts a number of K-L most similarly matched product group information of the suppliers. The L supplier group information and the K-L product group together compose the candidate product group information of the suppliers.

The first text similarity degree calculating sub-module calculates a first text similarity degree. The first text similarity degree represents a text similarity degree between the words of the search keywords and the supplier information keywords of the candidate product group information of the suppliers. The second text similarity degree calculating sub-module calculates a second text similarity degree. The second text similarity degree represents a text similarity degree between the phrases of the search keywords and the supplier information phrase list of the candidate product group information of the suppliers. The information selecting sub-module selects a preset number of candidate product group information of the suppliers, according to a descending order of the first text similarity degree and the second text similarity degree, as the matched product group information of the suppliers.

The present techniques use the characteristic weighted parameter to rank search results. The complex text matching algorithm with respect to the search keywords and the supplier product information used by the conventional techniques are not necessary under the present techniques. The calculation method of the characteristic weighted parameter is relatively simple and the characteristic weighted parameter may be pre-calculated. Thus, the present techniques may efficiently reduce the time of calculating search results during the search, thereby improving the searching efficiency.

The present techniques, based on relevant information of one or more suppliers, obtain major products of the suppliers and corresponding primary business coefficients of the product groups of the suppliers, and use a set of keywords to represent corresponding groups of the suppliers. When providing the suppliers to the buyer, the present techniques take into account the primary business coefficients of the sellers to evaluate matching of the business of the suppliers. The present techniques also provide pre-processing functionalities to the buyer during the process of providing best suppliers. Thus, the present techniques implement individualized search functionality to the buyer and enable the buyer to promptly and efficiently find the best suppliers that the buyer needs.

### BRIEF DESCRIPTION OF THE DRAWINGS

To better illustrate embodiments of the present disclosure, the following is a brief introduction of the FIGs to be used in the description of the embodiments. It is apparent that the following FIGs only relate to some embodiments of the present disclosure. A person of ordinary skill in the art can obtain other FIGs according to the FIGs in the present disclosure without creative efforts.

FIG. 1 illustrates a flowchart of an example method for searching supplier information based on transaction platform in accordance with the present disclosure.

FIG. 2 illustrates a diagram of an example flow of data input and output.

FIG. 3 illustrates a flowchart of an example method for processing category information.

FIG. 4 illustrates a flowchart of an example method for processing title keywords.

FIG. 5 illustrates a flowchart of an example method for processing attribute keywords.

FIG. 6 illustrates a flowchart of an example method for calculating the primary business coefficient.

FIG. 7 illustrates a flowchart of an example method for comprehensive information processing.

FIG. 8 illustrates a diagram of an example apparatus for searching supplier information based on transaction platform.

### DETAILED DESCRIPTION

To illustrate the purposes, characteristics, and advantages of the present techniques, the following descriptions are described by reference to the FIGs and some example embodiments.

At an e-commerce transaction platform, a seller may publish his/her supplied product information or category information from his/her webpage. If there are many types of numerous products, the seller may categorize the products according to certain rules. To provide a direct and intuitive impression to a buyer for the convenience of viewing, the seller may set display window information to directly display images, titles, and other information of the products at the front page of his/her webpage.

The conventional techniques, when providing a supplier to the buyer, often ignore a target of the products sold by the supplier, i.e., primary products sold by the buyer. Thus, the supplier provided to the buyer may not be the best supplier. As at the transaction platform, some suppliers may, in addition to their supplied or sold primary products, provide additional services. Such additional services may often not be their primary businesses. Thus, with respect to the buyer who purchases such additional service or products, if the supplier has not primarily targeted its business to such business, the user experience of the buyer is compromised.

The present techniques, based on relevant information of one or more suppliers, obtain major products of the suppliers and corresponding primary business coefficients of the product groups of the suppliers, and use a set of keywords to represent corresponding groups of the suppliers. When providing the suppliers to the buyer, the present techniques take into account the primary business coefficients of the sellers to evaluate matching of the business of the suppliers. The present techniques also provide pre-processing functionalities to the buyer during the process of providing best suppliers. Thus, the present techniques improve the user experience of the buyer.

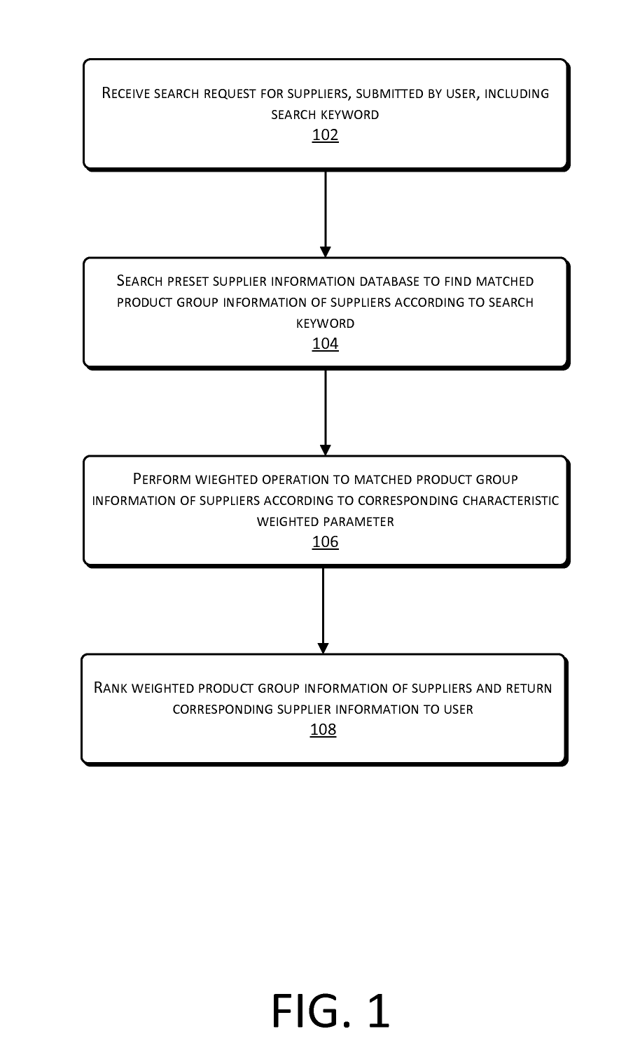

FIG. 1 illustrates a flowchart of an example method for searching supplier information based on transaction platform in accordance with the present disclosure.

At 102, a search request submitted by a user for one or more suppliers is received. The search request includes one or more search keywords.

At 104, a preset supplier information database is searched to find product group information of the suppliers that match the search keywords.

At 106, a weighted result of respective matched product group information of a respective supplier is obtained according to its respective characteristic weighted parameter.

At 108, the weighted product group information of the suppliers is ranked and corresponding supplier information is returned to the user.

For example, product information published by the suppliers at the transaction platform form a set of product information. If there is a large quantity of published product information, the suppliers may further group the product information according to certain rules. The product group information of the suppliers is structural information, which may be different from data sources for general search (such as data sources accepted by search engines GOOGLE™ and BAIDU™). The product group information of a respective supplier is a description of the supplier and its products, which may be based on one or more of the following information including a primary keyword of the grouping of the supplier, a type of the supplier, a scale of the supplier, a category of the product supplied by the supplier, and/or a product keyword of the supplier, etc.

In one example embodiment, the characteristic weighted parameters of the product group information of the suppliers may be pre-calculated. For example, the characteristic weighted parameters including a primary business coefficient. The following operations may be used to calculate the characteristic weighted parameter.

At a sub-step S11, a first percentage and a second percentage are calculated. The first percentage represents a percentage of a number of products in a respective product group of the respective supplier to a total number of products of the respective supplier. The second percentage represents a number of products with a characteristic identification in the respective group of the respective supplier to a total number of products with the characteristic identification of the respective supplier. For instance, the characteristic identifications may include a display recommendation identification which means the corresponding product is listed at the display window of the front page of the supplier's webpage.

At a sub-step S12, a first weight of the first percentage and a second weight of the second percentage are used for weighted calculation. The second weight may be higher than the first weight.

At a sub-step S13, the weighted first percentage and the weighted second percentage are combined to obtain the primary business coefficient of the respective product group of the respective supplier.

For example, the preset supplier information database may include one or more supplier information keywords and one or more supplier information phrase lists corresponding to the respective product group information of the respective supplier. The supplier information keywords may include one or more title keywords. The title keyword may be obtained through obtaining the product title information of the product groups of the suppliers and word-segmenting the product title information. The supplier information phrase list may be obtained through obtaining the product title information of the product groups of the suppliers and phrase-segmenting the product title information.

For another example, the search method may also be based on product group names. The supplier information keywords may also include one or more product group keywords. The product group keywords may be obtained through obtaining a respective product group name of the respective supplier and segmenting the respective product group name of the respective supplier.

For another example, the search method may also be based on a category. The supplier information keywords may also include one or more category keywords. The category keywords may be obtained through obtaining respective category information of the respective product of the respective supplier and extracting the category keywords from the respective category information. The respective category information may include description information of a root category and description information of a leaf category.

For another example, the supplier information keywords may also include one or more attribute keywords. The attribute keywords may be obtained through obtaining attribute information of the respective product of the respective supplier and extracted from the category attribute information.

To facilitate understanding of the present techniques, the following example embodiment of the present disclosure further details a process for extracting the supplier information keywords and the supplier information phrase lists and calculating the characteristic weighted parameter.

1. Input and Output Data

For example, input data from a supplier database may include 5 tables, each representing category information, product information, attribute information, display window information, and group information. To facilitate illustration, names and fields of the tables may be exemplified in the following tables.

TABLE 1

| Serial No | 1 | 2 | 3 | 4 | 5 |
|---|---|---|---|---|---|
| Category | CATEGORY_{—} | CATEGORY_{—} | CATEGORY_{—} | CATEGORY_{—} | |
| information | ROOT_ID | ROOT_DESC | LEAF_ID | LEAF_DESC | |
| table | | | | | |
| Product | CATEGORY_{—} | PRODUCT_{—} | COMPANY_{—} | SUBJECT | GROUP_ID |
| information | LEAF_ID | ID | ID | | |
| table | | | | | |
| Attribute | PRODUCT_{—} | ATTR_ID | ATTR_{—} | | |
| information | ID | | VALUE | | |
| table | | | | | |
| Display | COMPANY_{—} | GROUP_ID | PRODUCT_{—} | | |
| window | ID | | ID | | |
| information | | | | | |
| table | | | | | |
| Group | GROUP_ID | COMPANY_{—} | NAME | | |
| information | | ID | | | |
| table | | | | | |

The representation of the input data fields are illustrated as follows:

(1) COMPANY_ID represents identification (ID) of a supplier.

(2) GROUP_ID represents ID of a product group.

(3) PRODUCT_ID represents ID a product.

(4) SUBJECT represents a name of the product.

(5) CATEGORY_ROOT_ID represents ID of a root category.

(6) CATEGORY_ROOT_DESC represents a description of the root category.

(7) CATEGORY_LEAF_ID represents ID of a leaf category.

(8) CATEGORY_LEAF_DESC represents a description of the leaf category.

(9) ATTR_ID represents ID of an attribute.

(10) ATTR_VALUE represents a value of the attribute.

(11) NAME represents a name of the product group.

In the example embodiment, after the supplier information keywords and the supplier information phrase lists are extracted and the primary business coefficients are calculated, fields in the output data table may be as shown in Table 2.

TABLE 2

| 1 | 2 | 3 | 4 | 5 | 6 |
|---|---|---|---|---|---|
| COMPANY_{—} | GROUP_{—} | NAME_{—} | CATEGORY_{—} | CATEGORY_{—} | CATEGORY_{—} |
| ID | ID | KEYWORDs | ROOT_IDs | LEAF_IDs | KEYWORDs |
| 7 | 8 | 9 | 10 | 11 | 12 |
| SUBJECT_{—} | ATTR_{—} | GROUP_{—} | SHOWCASE_{—} | SCORE | PHRASEs |
| KEYWORDs | KEYWORDs | SIZE | SIZE | | |

The representation of the output data fields are illustrated as follows:

(1) COMPANY_ID represents the ID of the supplier.

(2) GROUP_ID represents the ID of the group.

(3) NAME_KEYWORDs represents keyword of the name of the product group.

(4) CATEGORY_ROOT_IDs represents a list of IDs of root categories.

(5) CATEGORY_LEAF_IDs represents a list of IDs of leaf categories.

(6) CATEGORY_KEYWORDs represents a list of keywords of categories

(7) SUBJECT_KEYWORDs represents a list of title keywords.

(8) ATTR_KEYWORDs represents a list of attribute keywords.

(9) GROUP_SIZE represents a size of the product group, i.e., a number of products contained in the product group.

(10) SHOWCASE_SIZE represents a size of a display window, i.e., a number of products in the product group at the display window.

(11) SCORE represents a primary business coefficient.

(12) PHRASEs represent a list of supplier information phrases.

2. Data Processing Flow

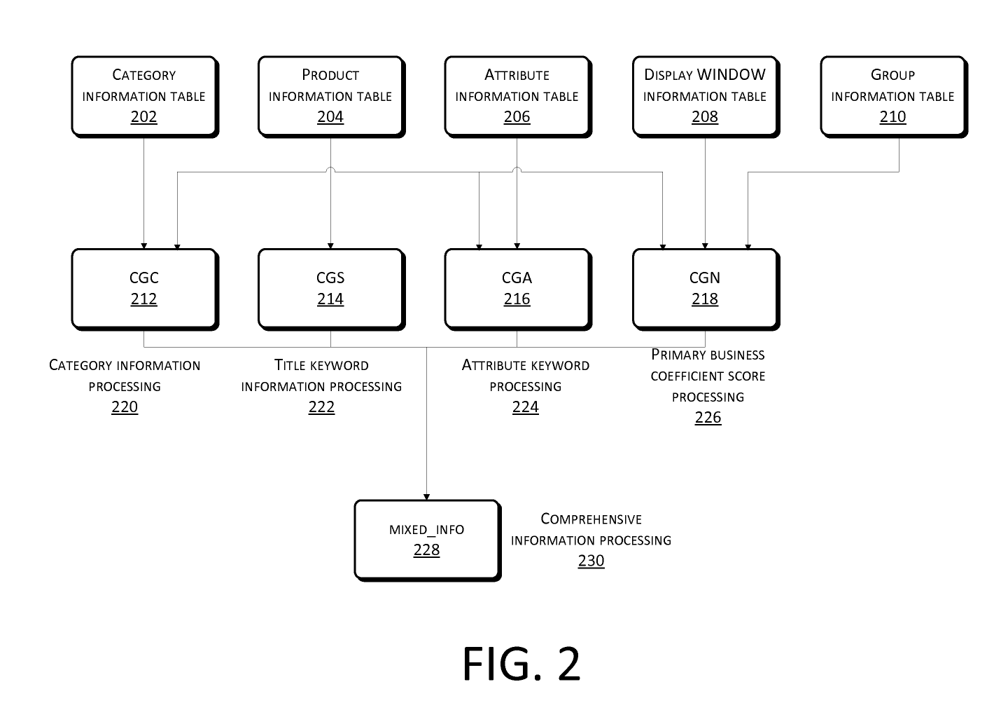

FIG. 2 illustrates a diagram of an example flow of data input and output. The input data are the five tables as shown in FIG. 2, which includes a category information table 202, a product information table 204, an attribute information table 206, a display window information table 208, and a group information table 210. Four tables including a table CGC 212, a table CGS 214, a table CGA 216, and a table CGN 218 are obtained from the input data after four steps of processing including a category information processing 220, a title keyword processing 222, an attribute keyword processing 224, and a primary business coefficient score processing 226. Information of the four tables is combined to obtain a result of modeling of the primary business. A mixed_info table 228 through a comprehensive information processing 230 is the table of the last output data.

(1) Category Information Processing

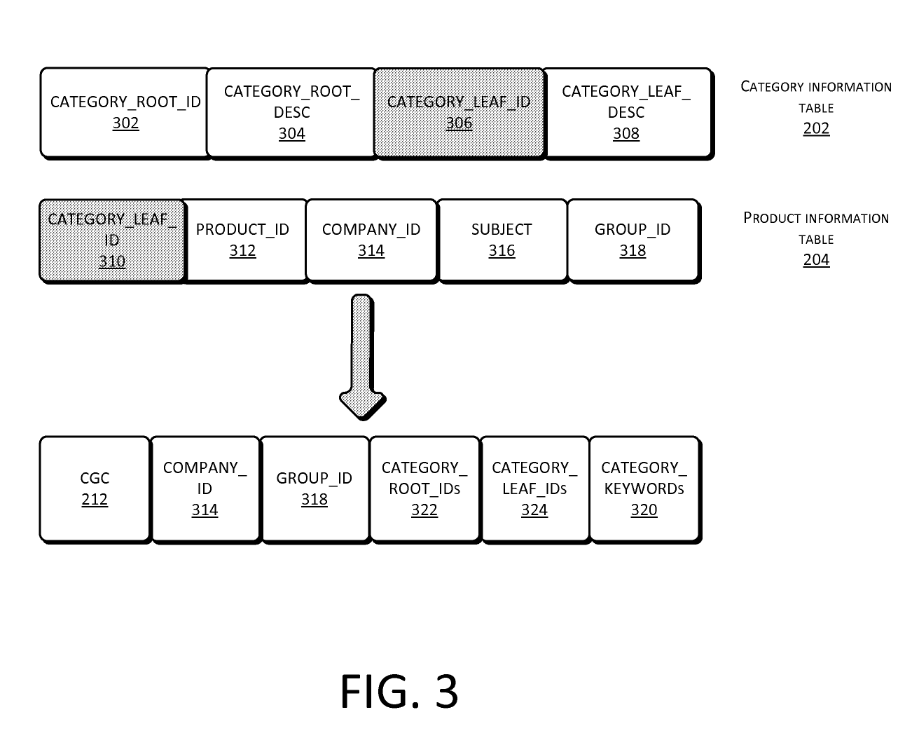

FIG. 3 illustrates a flowchart of an example method for processing category information. The category information table 202 includes a CATEGORY_ROOT_ID 302, a CATEGORY_ROOT_DESC 304, a CATEGORY_LEAF_ID 306, and a CATEGORY_LEAF_DESC 308. The product information table 204 includes a CATEGORY_{‘}LEAF_ID 310, a PRODUCT_ID 312, a COMPANY_ID 314, a SUBJECT 316, and a GROUP_ID 318. The CATEGORY_LEAF_ID 306, which represents the leaf category information, correlates the category information table 202 with the product information table 204 to obtain the root category information and the leaf category information of each product. Category keywords are then extracted from the CATEGORY_ROOT_DESC 304 and the CATEGORY_LEAF_DESC 308. For example, the segment processing may be applied to the CATEGORY_ROOT_DESC 304 and the CATEGORY_LEAF_DESC 308 to obtain CATEGORY_KEYWORDs 320 representing a list of category keywords.

Such processing may obtain the table CGC 212 including the following fields: the company ID 314 representing the ID of the supplier, the GROUP_ID 318 representing the ID of the group, CATEGORY_ROOT_IDs 322 representing a list of IDs of root categories, CATEGORY_LEAF_IDs 324 representing a list of IDs of leaf categories, and the CATEGORY_KEYWORDS 320.

(2) Title Keyword Processing

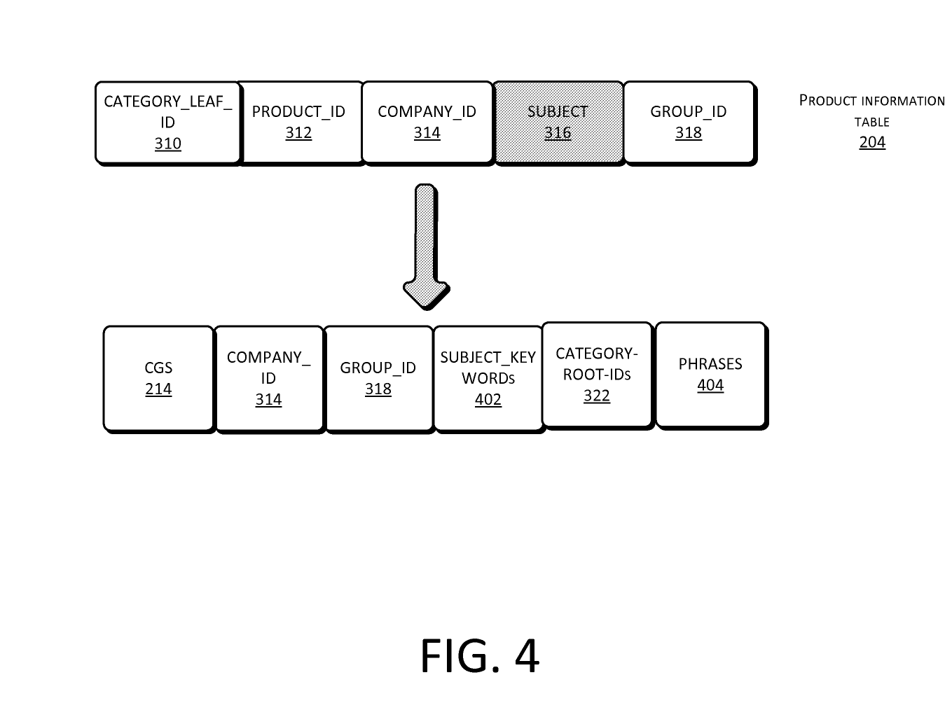

FIG. 4 illustrates a flowchart of an example method for processing title keywords. Such processing collects the subject fields of all products under each product group, and segmenting the subject into words and/or phrases. The word-segmenting result includes one or more keywords and information relating to appearance frequencies of the keywords. The phrase-segmenting result includes one or more phrases and information relating to appearance frequencies of the phrases.

Such processing may obtain the table CGS 214 including the following fields: the COMPANY_ID 314 representing the supplier, the GROUP_ID 318 representing the group, SUBJECT_KEYWORDS 402 representing a list of title keywords, the CATEGORY_ROOT_IDs 322 representing a list of IDs of root categories, and PHRASEs 404 representing a list of supplier information phrases.

(3) Attribute Keyword Processing

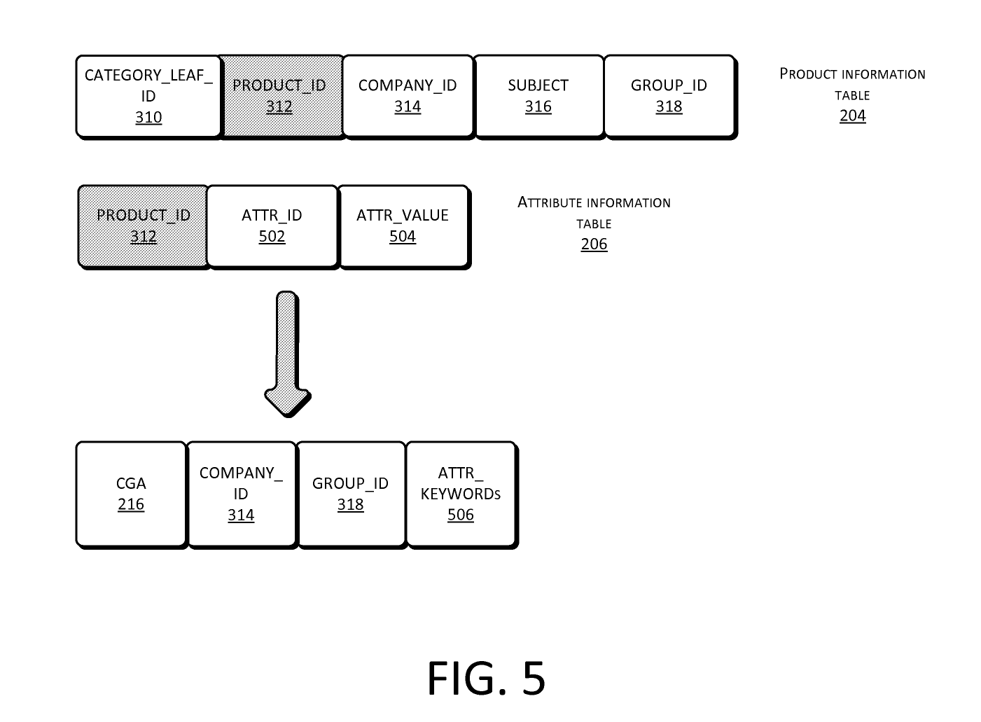

FIG. 5 illustrates a flowchart of an example method for processing attribute keywords. Such processing uses the PRODUCT_ID 312 to correlate the product information table 204 with the attribute information table 206, conducts segment processing and word frequency calculation of the correlated tables, and obtains a list of attribute keywords of the product group of the suppliers including the word frequency information. The attribute information table 206 includes the following fields: the PRODUCT_ID 312, an ATTR_ID 502 representing ID of the attribute, an ATTR_VALUE 504 representing a value of the attribute.

Such processing may obtain the table CGA 216 including the following fields: the COMPANY_ID 314 representing the supplier, the GROUP_ID 318 representing the group, and ATTR_KEYWORDs 506 representing a list of attribute keywords.

(4) Primary Business Coefficient Calculating

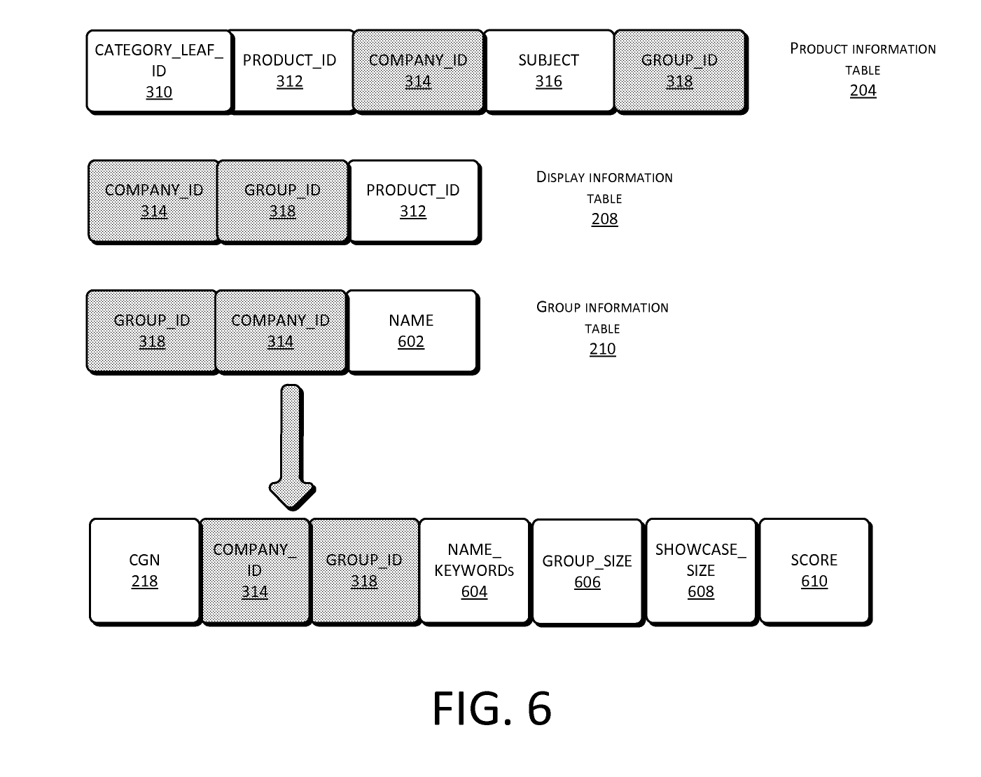

FIG. 6 illustrates a flowchart of an example method for calculating the primary business coefficient. Such processing uses the PRODUCT_ID 312 and the GROUP_ID 318 to correlate the product information table 204, the display window information table 208, and the group information table 210 and calculates a score of each of the product group of the supplier. The group information table 210 includes the GROUP_ID 318, the COMPANY_ID 314, and a NAME 602. The field of NAME 602 is segmented. For instance, the segmenting result may include the keywords without the word frequency information.

The primary business coefficient may be calculated by using the following formula:

W₁*P₁+W₂*P₂

P₁ represents a percentage of a number of products in the product group of a supplier to a total number of products of the supplier. P₂ represents a percentage of a number of products in the product group of the supplier at one or more display windows to a total number of products of the supplier at the display windows. Each of W₁ and W₂ represents a weight of P₁ and P₂. For example, W₂>W₁, W₂ may be 0.75, and W₁ may be 0.25.

The present techniques may obtain the table CGN 218 including the following fields: the COMPANY_ID 314 representing ID of the supplier, the GROUP_ID 318 representing ID of the group, NAME_KEYWORDs 604 representing keywords of the name of the group, a GROUP_SIZE 606 representing a number of products included in the product group, a SHOWCASE_SIZE 608 representing a number of displayed products in the product group, a SCORE 610 representing the primary business coefficient.

(5) Comprehensive Information Processing

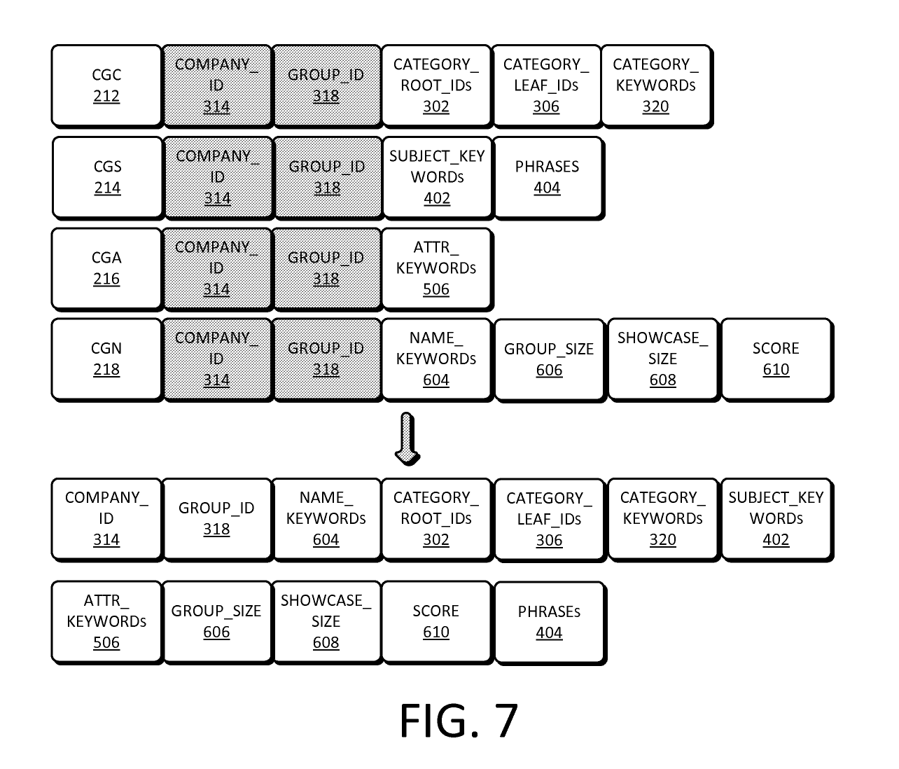

FIG. 7 illustrates a flowchart of an example method for comprehensive information processing. The previously obtained SUBJECT_KEYWORDS 402, the ATTR_KEYWORDS 506, and the PHRASEs 404 only include appearance frequencies of the keywords and phrases. Such frequencies may be divided by the corresponding GROUP_SIZE 606 to obtain the percentage information. The COMPANY_ID 314 and the GROUP_ID 318 are used to correlate all of the above information, i.e., the table CGC 212, the table CGS 214, the table CGA 216, and the table CGN 218, to obtain final output result of the primary business through modeling (see Table 2).

At 102, the one or more search keywords in the search request submitted by the user for the one or more suppliers may include product information keywords submitted by the user or the product information keywords submitted by the user and product information keywords generated by a back end.

For example, the search request may include fields of a request for quotation (RFQ) as shown in the following table. RFQ represents product information input by the buyer at the e-commerce transaction website that the buyer intends to purchase, which may include a product information keyword, an individualized index, etc.

| RFQ field | Explanation |
|---|---|
| RFQ_id | Unique identificaiton of RFQ |
| Category_id | Product category information |
| | submitted by the user |
| Name | Product information keyword |
| | submitted by the user |
| Comment | Product information keyword |
| | generated by the back-end. For |
| | instance, the product information |
| | keyword may be input by an operation |
| | staff to facilitate the user for better |
| | product search |
| Scale | Supplier scale required by the user |
| Market | Primary market of the supplier |
| | required by the user |

In the example embodiment the user may submit basic product information keywords as search inquiry information. According to the product information keywords submitted by the user, the back-end may process them into more standard product information keywords according to one or more rules. These two types of product information keywords may be combined for processing. In addition, the user may also submit more individualized indexes as shown above as the search inquiry information. In the following search processing, such individualized indexes are used as further filtering conditions of the suppliers.

In the example embodiment, the keywords included in the RFQ information submitted by the front end may be segmented to obtain the search keywords. For example, if the category information included in the RFQ includes chemical category or medical category, special processing is applied in the segment processing, which are separate from the segment processing to the other industries. For instance, a chemistry dictionary may be used for segmenting. If the category information of the RFQ is empty or null, it is assumed that the buyer has no requirements to the category. The segmenting result includes one or more words and one or more phrases. That is, the search keywords obtained after the segmenting may include phrases and words. Certainly, in practice, the search keyword after the segmenting may only include words.

The preset supplier information database may include the one or more supplier information keywords and the supplier information phrase lists corresponding to the product group information of the suppliers. In one example embodiment, the search keywords may include the phrase field and the word field. For example, the operation at 104 may include the following sub-steps.

At sub-step S21, the phrases from the phrase fields are used to search the supplier information phrase list to extract a number of K most similarly matched product group information of the suppliers as matched product group information of the suppliers. K represents a preset number threshold.

At sub-step S22, if the number of found product group information of the suppliers based on the phrases from the phrase field is L and L<K, the words from the word field are further used to search the supplier information keywords and a number of K-L most similarly matched product information of the suppliers are extracted. The L product group information of the suppliers and the K-L product group compose the matched product group information of the suppliers.

For another example, the search keywords may include one or more words from the word field. The operation at 104 may include the following sub-steps.

At sub-step 23, the words from the word field are used to search the supplier information keywords to extract a number of K most similarly matched product group information of the suppliers are extracted as matched product group information of the suppliers. K represents a preset number threshold.

In another example embodiment of the present disclosure, the search keywords include words and phrases. The operation at 104 may include the following sub-steps.

At sub-step S31, the phrases are used to search the supplier information phrase list to extract a number of K most similarly matched product group information of the suppliers as candidate product group information of the suppliers. K represents a preset number threshold.

At sub-step 32, if the number of found product group information of the suppliers based on the phrases is L and L<K, the words are further used to search the supplier information keywords and a number of K-L most similarly matched product information of the suppliers are extracted. The L product group information of the suppliers and the K-L product group compose the candidate product group information of the suppliers.

At sub-step 33, a first text similarity degree is calculated. The first text similarity degree represents a text similarity degree between the words of the search keywords and the supplier information keywords of the candidate product group information of the suppliers.

At sub-step 34, a second text similarity degree is calculated. The second text similarity degree represents a text similarity degree between the phrases of the search keywords and the supplier information phrase list of the candidate product group information of the suppliers.

At sub-step 35, a preset number of candidate product group information of the suppliers are selected, according to a descending order of the first text similarity degree and the second text similarity degree, as the matched product group information of the suppliers.

For example, the following calculation method may be used for calculating the similarity degree.

RFQ_Name and RFQ_Comment included in the RFQ have been processed, such as segmenting and converting from plurality or singularity, to obtain a series of words and phrases. The similarity degree includes two parts, a word similarity degree and a phrase similarity degree. The following introduces the methods for calculating the word field similarity degree and the phrase field similarity degree respectively.

(1) Word Field Similarity Degree

The similarity degree between the supplier information keyword and the RFQ (or the first text similarity degree) may be calculated by using the following formula:

$$Similarity = {\sum }_{i} weight ( {W}_{i} ) * percentage ( {W}_{i} ) * NameorComment ( {W}_{i} )$$

weight(Wᵢ) represents a weight corresponding to the word field's attribute. percentage (Wᵢ) represents a percentage of the word field to the product group information of the supplier. NameOrComment(Wᵢ) represents a weight of the word field matching the supplier information keyword that belongs to the product information keyword. The value of the weight NameOrComment(Wᵢ) may be a weight Name(Wᵢ) that the word field matching the supplier information keyword that belongs to the product information keyword submitted by the user, or the value of the weight NameOrComment(Wᵢ) may be a Comment(Wᵢ) that the word field matching the supplier information keyword that belongs to the product information keyword generated by the back-end. Name represents a weight of the subject of the RFQ while Comment represents a weight of a field manually appended by the operational staff. Different weights may be assigned according to the two different situations.

(2) Phrase Field Similarity Degree

The similarity degree between the supplier information phrase list and the RFQ (or the second text similarity degree) may be calculated by using the following formula:

$$Similarity = {\sum }_{i} weight ( {PH}_{i} ) * percentage ( {PH}_{i} ) * NameorComment ( {PH}_{i} )$$

weight(PHᵢ) represents a weight corresponding to the phrase field's attribute. percentage (PHᵢ) represents a percentage of the phrase field to the product group information of the supplier. NameOrComment(PHᵢ) represents a weight of the phrase field matching the supplier information keyword that belongs to the product information keyword. The value of the weight NameOrComment(PHᵢ) may be a weight Name(PHᵢ) that the phrase field matching the supplier information keyword that belongs to the product information keyword submitted by the user, or the value of the weight NameOrComment(PHᵢ) may be a Comment(PHᵢ) that the phrase field matching the supplier information keyword that belongs to the product information keyword generated by the back-end. Name represents a weight of the subject of the RFQ while Comment represents a weight of a field manually appended by the operational staff. Different weights may be assigned according to the two different situations.

The similarity degree algorithm in this example embodiment primarily includes two dimensions: the text similarity degree and the primary business coefficient. The similarity degree score is the comprehensive result of the two dimensions. The text similarity degree is classified from the perspective of the dimensions of types of the matched keywords, which may include word field's text similarity degree and phrase field's similarity degree. The primary business coefficient is a comprehensive index based on a percentage of product groups and a percentage of product groups at display, which may be used to perform weighted calculation of the product groups when search is performed.

Certainly, the above storage structure in the pre-set supplier information database and the corresponding methods for finding and searching the product group information of the suppliers that match the keywords are just examples. One of ordinary skill in the art may freely use such methods or others depending on the actual situation. The present disclosure does not impose any restriction herein.

At 106, the product group information of the suppliers may be ranked directly according to the matched primary business coefficients corresponding to the product group information of the suppliers. Alternatively, scores of the product group information of the suppliers may be calculated based on the first text similarity degree, the second text similarity degree, and the primary business coefficient, and the product group information of the suppliers may be ranked according to their scores.

For example, the scores of the product group information of the suppliers may be calculated by using the following formula:

Similarity=TextSimilarity*(1−Wₘ)+PrimiaryBusinessCoef ficient*Wₘ

Wₘ represents a weight of the primary business coefficient. TextSimilarity represents a score of the text similarity degree.

In another example embodiment of the present disclosure, the characteristic attribute parameter may also include a public index score and an individualized index score of the matched product group information of the suppliers.

For example, the public index score may be calculated by using the following formula:

Score_{public}=Σᵢ*Wᵢ

i may represent any integer. For instance, P₁ represents an active degree of the supplier and P₂ represents a bid responding degree of the supplier while W₁ and W₂ represent their respective weight.

For example, the individualized index score may be calculated by using the following formula:

Score_{personzlied}=Σᵢ Scoreᵢ

i may represent any integer.

Certainly, the above selection of characteristic weighted parameters and method for ranking the product group information of the suppliers search result based on the characteristic weighted parameters are just examples. The present disclosure does not impose any restriction herein.

For brevity of illustration, the above example method embodiments are described by reference to a combination of a series of actions. One of ordinary skill in the art would appreciate that the preset disclosure shall not be limited by the sequence of such described actions. Some steps may use other sequences or parallel processing. In addition, one of ordinary skill in the art would appreciate that the embodiments described herein are examples and the actions or modules described therein may not be necessary for the present techniques.

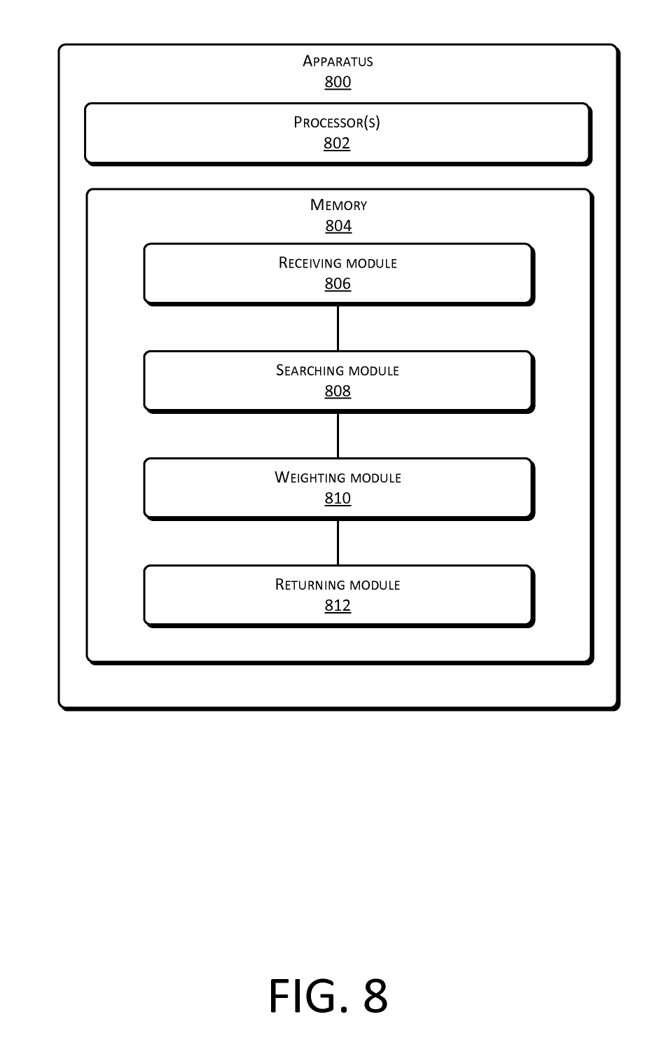

FIG. 8 illustrates a diagram of an example apparatus 800 for searching supplier information based on transaction platform. A supplier may have one or more product group information. Each of the product group information has its corresponding characteristic weight.

The apparatus 800 in FIG. 8 may include one or more processor(s) 802 and memory 804. The memory 804 is an example of computer-readable media. As used herein, “computer-readable media” includes computer storage media and communication media.

Computer storage media includes volatile and non-volatile, removable and non-removable media implemented in any method or technology for storage of information such as computer-executable instructions, data structures, program modules, or other data. Examples of computer storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage apparatus, or any other non-transmission medium that can be used to store information for access by a computing apparatus. In contrast, communication media may embody computer-readable instructions, data structures, program modules, or other data in a modulated data signal, such as a carrier wave. As defined herein, computer storage media does not include communication media.

The memory 804 may store therein program units or modules and program data. In the example of FIG. 8, the memory 804 may store therein a request receiving module 806, a searching module 808, a weighting module 810, and a returning module 812.

The request receiving module 806 receives a search request for one or more suppliers submitted by a user. The search request includes one or more search keywords. The searching module 808 searches a preset supplier information database to find matched product group information of the suppliers according to the search keywords. The weighting module 810 performs weighting operations, such as calculating or assigning weights, to the matched product group information of the suppliers according to their respective characteristic weighted parameters. The returning module 812 ranks the weighted product group information of the suppliers and returns corresponding supplier information to the user.

For example, the characteristic weighted parameter may include a primary business coefficient. The primary business coefficient may be obtained as follows.

A first percentage and a second percentage are calculated. The first percentage represents a percentage of a number of products in a respective product group of the respective supplier to a total number of products of the respective supplier. The second percentage represents a number of products with characteristic identifications in the respective group of the respective supplier to a total number of products with the characteristic identification of the respective supplier. The characteristic identification may include display recommendation identification.

A first weight of the first percentage and a second weight of the second percentage are used for weighted calculation. The second weight may be higher than the first weight. The weighted first percentage and the weighted second percentage are combined to obtain the primary business coefficient of the respective product group of the respective supplier.

For example, the preset supplier information database may include one or more supplier information keywords and a supplier information phrase list corresponding to the respective product group information of the respective supplier. The supplier information keywords may include one or more title keywords. The title keyword may be obtained by obtaining respective product title information of the respective product group of the respective supplier and segmenting the respective product title information into words. The supplier information phrase list may be obtained by obtaining respective product title information of the respective product group of the respective supplier and segmenting the respective product title information into phrases.

For another example, the supplier information keywords may also include one or more product group keywords. The product group keywords may be obtained by obtaining a respective product group name of the respective supplier and segmenting the respective product group name of the respective supplier into words.

For another example, the supplier information keywords may also include one or more category keywords. The category keywords may be obtained by obtaining respective category information of the respective product of the respective supplier and extracting the category keywords from the respective category information. The respective category information may include description information of a root category and description information of a leaf category.

For another example, the supplier information keywords may also include one or more attribute keywords. The attribute keywords may be obtained by obtaining attribute information of the respective product of the respective supplier and extracted from the category attribute information.

In one example embodiment, the search keywords may include one or more words and/or phrases. The searching module 808 may include a first extracting sub-module and a second extracting sub-module. The first extracting sub-module searches the supplier information phrase list to extract a number of K most similarly matched product group information of the suppliers as matched product group information of the suppliers. K represents a preset number threshold.

If the number of found product group information of the suppliers based on the phrases is L and L<K, the second extracting sub-module further uses the words to search the supplier information keywords and extracts a number of K-L most similarly matched product information of suppliers. The L supplier group information and the K-L product group information of the suppliers together compose the matched product group information of the suppliers.

In another example embodiment, the search keywords may include one or more words and/or phrases. The searching module 808 may include a first candidate information extracting sub-module, a second candidate information extracting sub-module, a first text similarity degree calculating module, a second text similarity calculating module, and an information selecting sub-module.

The first candidate information extracting sub-module searches the preset supplier information database by using the phrases to extract a number of K most similarly matched product group information of the suppliers as candidate product group information of the suppliers. K represents a preset number threshold.

If the number of found product group information of the suppliers based on the phrases is L and L<K, the second candidate information extracting sub-module further uses the words to search the supplier information keywords and extracts a number of K-L most similarly matched product group information of the suppliers. The L product group information of the suppliers and the K-L product group information of the suppliers together compose the candidate product group information of the suppliers.

The first text similarity degree calculating sub-module calculates a first text similarity degree. The first text similarity degree represents a text similarity degree between the words of the search keywords and the supplier information keywords of the candidate product group information of the suppliers.

The second text similarity degree calculating sub-module calculates a second text similarity degree. The second text similarity degree represents a text similarity degree between the phrases of the search keywords and the supplier information phrase list of the candidate product group information of the suppliers.

The information selecting sub-module selects a preset number of candidate product group information of the suppliers, according to a descending order of the first text similarity degree and the second text similarity degree, as the matched product group information of the suppliers.

The present techniques in the example apparatus embodiments are similar to those in the example method embodiments, and thus described in brevity. The relevant portions in the example apparatus embodiments may be referenced to the corresponding portions in the example method embodiments.

One of ordinary skill in the art should understand that the embodiments of the present disclosure can be methods, systems, or the programming products of computers. Therefore, the present disclosure can be implemented by hardware, software, or in combination of both. In addition, the present disclosure can be in a form of one or more computer programs containing the computer-executable codes which can be implemented in the computer-executable storage medium (including but not limited to disks, CD-ROM, optical disks, etc.).

The present disclosure is described by referring to the flow charts and/or block diagrams of the method, device (system) and computer program of the embodiments of the present disclosure. It should be understood that each flow and/or block and the combination of the flow and/or block of the flowchart and/or block diagram can be implemented by computer program instructions. These computer program instructions can be provided to the general computers, specific computers, embedded processor or other programmable data processors to generate a machine, so that a device of implementing one or more flows of the flow chart and/or one or more blocks of the block diagram can be generated through the instructions operated by a computer or other programmable data processors.

These computer program instructions can also be stored in other computer-readable storage which can instruct a computer or other programmable data processors to operate in a certain way, so that the instructions stored in the computer-readable storage generate a product containing the instruction device, wherein the instruction device implements the functions specified in one or more flows of the flow chart and/or one or more blocks of the block diagram.

These computer program instructions can also be loaded in a computer or other programmable data processors, so that the computer or other programmable data processors can operate a series of operation steps to generate the process implemented by a computer. Accordingly, the instructions operated in the computer or other programmable data processors can provides the steps for implementing the functions specified in one or more flows of the flow chart and/or one or more blocks of the block diagram.

The embodiments are merely for illustrating the present disclosure and are not intended to limit the scope of the present disclosure. It should be understood for persons in the technical field that certain modifications and improvements can be made and should be considered under the protection of the present disclosure without departing from the principles of the present disclosure.

It is noted that any relational terms such as “first” and “second” in this document are only meant to distinguish one entity from another entity or one operation from another operation, but not necessarily request or imply existence of any real-world relationship or ordering between these entities or operations. Moreover, it is intended that terms such as “include”, “have” or any other variants mean non-exclusively “comprising”. Therefore, processes, methods, articles or devices which individually include a collection of features may not only be including those features, but may also include other features that are not listed, or any inherent features of these processes, methods, articles or devices. Without any further limitation, a feature defined within the phrase “include a . . . ” does not exclude the possibility that process, method, article or device that recites the feature may have other equivalent features.

The above descriptions of the example embodiments illustrate an example method and an example apparatus for searching supplier information based on transaction platform. The example embodiments illustrate the principles and their implementations in accordance with the present disclosure. The embodiments are merely for illustrating the methods and core concepts of the present disclosure and are not intended to limit the scope of the present disclosure. It should be understood by one of ordinary skill in the art that certain modifications, replacements, and improvements can be made and should be considered under the protection of the present disclosure without departing from the principles of the present disclosure. The descriptions herein shall not be understood to restrict the present disclosure.

What is claimed is:

1. A method comprising:
receiving a search request for one or more suppliers, the search request including one or more search keywords;
searching a preset supplier information database to find one or more product group information of the one or more suppliers according to the one or more search keywords;
performing a weighted operation to each of the one or more product group information according to a respective characteristic weighted parameter of the one or more product group information; and
ranking the weighted one or more product group information.

2. A method as recited in claim 1, further comprising returning corresponding supplier information based on a result of the ranking

3. A method as recited in claim 1, wherein:
each of the one or more suppliers has one or more product group information; and
each product group information has a corresponding characteristic weighted parameter.

4. A method as recited in claim 1, wherein the respective characteristic weighted parameter includes a primary business coefficient.

5. A method as recited in claim 1, further comprising obtaining the respective characteristic weighted parameters, the obtaining including:
calculating a first percentage that represents a percentage of a number of products in a respective product group of a respective supplier to a total number of products of the respective supplier;
calculating a second percentage that represents a number of products with characteristic identifications in the respective product group of the respective supplier to a total number of products with the characteristic identification of the respective supplier;
applying a first weight to the first percentage and a second weight to the second percentage to obtain a weighted first percentage and a weighted second percentage respectively; and
obtaining a respective primary business coefficient of the respective product group of the respective supplier based on the weighted first percentage and the weighted second percentage.

6. A method as recited in claim 5, wherein the characteristic identifications comprise a display recommendation identification.

7. A method as recited in claim 1, wherein the preset supplier information database comprises one or more supplier information keywords and a supplier information phrase list corresponding to the one or more product group information of the one or more suppliers.

8. A method as recited in claim 7, wherein:
the one or more supplier information keywords comprise one or more title keywords; and
the method further comprising:
obtaining product title information of one or more product groups of the one or more suppliers;
segmenting the product title information into one or more words to obtain the one or more title keywords; and
segmenting the product title information into one or more phrases to obtain the supplier information phrase list.

9. A method as recited in claim 7, wherein:
the one or more supplier information keywords comprise one or more product group keywords; and
the method further comprising:
obtaining product group names of one or more product groups of the one or more suppliers; and
segmenting the product group names to obtain the one or more product group keywords.

10. A method as recited in claim 7, wherein:
the one or more supplier information keywords comprise one or more category keywords; and
the method further comprising:
obtaining category information of one or more product groups of the one or more suppliers, respective category information including description information of a root category and description information of a leaf category; and
extracting the one or more category keywords from the category information.

11. A method as recited in claim 7, wherein:
the one or more supplier information keywords comprise one or more attribute keywords; and
the method further comprising:
obtaining attribute information of one or more product groups of the one or more suppliers; and
extracting the one or more attribute keywords from the attribute information.

12. A method as recited in claim 1, wherein:
the one or more search keywords comprise one or more words and one or more phrases; and
the searching the preset supplier information database to find the one or more product group information of the one or more suppliers according to the one or more search keywords comprises:
using the one or more phrases to search the supplier information phrase list to extract a number of K most similarly product group information, K representing a preset number threshold;
if a number of found product group information based on the phrases is a number of L product group information and L<K, using the one or more words to search the supplier information keywords and extracting a number of K-L most similarly matched product group information; and
obtaining the one or more product group information that include the L product group information and the K-L product group information.

13. A method as recited in claim 1, wherein:
the one or more search keywords comprise one or more words and one or more phrases; and
the searching the preset supplier information database to find the one or more product group information of the one or more suppliers according to the one or more search keywords comprises:
using the one or more phrases to search the supplier information phrase list to extract a number of K most similarly product group information as first candidate product group information, K representing a preset number threshold;
if a number of found product group information based on the phrases is a number of L product group information and L<K, using the one or more words to search the supplier information keywords and extracting a number of K-L most similarly matched product group information as second candidate product group information;
obtaining candidate product group information that includes the L product group information as the first candidate product group information and the K-L product group information as the second candidate product group information;
calculating a first text similarity degree representing a text similarity degree between the one or more words of the search keywords and supplier information keywords of the candidate product group information of the suppliers;
calculating a second text similarity degree representing a text similarity degree between the one or more phrases of the search keywords and a supplier information phrase list of the candidate product group information of the suppliers; and
selecting a preset number of product group information, according to a descending order of the first text similarity degree and the second text similarity degree, from the candidate product group information.

14. An apparatus comprising:
a receiving module that receives a search request for one or more suppliers, the search request including one or more search keywords, each of the one or more suppliers having one or more product group information, each product group information having a respective characteristic weighted parameter;
a searching module that searches a preset supplier information database to find one or more product group information of the one or more suppliers according to the one or more search keywords;
a weighting module that performs a weighted operation to each of the one or more product group information according to the respective characteristic weighted parameter of the one or more product group information; and
a returning module that ranks the weighted one or more product group information.

15. An apparatus as recited in claim 14, wherein the returning module further returns corresponding supplier information based on a result of the ranking

16. An apparatus as recited in claim 14, wherein the characteristic weighted parameter includes a primary business coefficient.

17. An apparatus as recited in claim 14, wherein:
the one or more search keywords comprise one or more words and one or more phrases; and
the searching module further includes:
a first extraction sub-module that uses the one or more phrases to search the supplier information phrase list to extract a number of K most similarly product group information, K representing a preset number threshold; and
a second extraction sub-module that, when a number of found product group information based on the phrases is a number of L product group information and L<K, uses the one or more words to search the supplier information keywords and extracting a number of K-L most similarly matched product group information,
wherein the one or more product group information include the L product group information and the K-L product group information.

18. An apparatus as recited in claim 14, wherein:
the one or more search keywords comprise one or more words and one or more phrases; and
the searching module further includes:
a first extraction sub-module that uses the one or more phrases to search the supplier information phrase list to extract a number of K most similarly product group information as first candidate product group information, K representing a preset number threshold;
a second extraction sub-module that, when a number of found product group information based on the phrases is a number of L product group information and L<K, uses the one or more words to search the supplier information keywords and extracting a number of K-L most similarly matched product group information as second candidate product group information, wherein candidate product group information includes the L product group information as the first candidate product group information and the K-L product group information as the second candidate product group information;
a first text similarity degree calculation sub-module that calculates a first text similarity degree representing a text similarity degree between the one or more words of the search keywords and supplier information keywords of the candidate product group information of the suppliers;
a second text similarity degree calculation sub-module that calculates a second text similarity degree representing a text similarity degree between the one or more phrases of the search keywords and a supplier information phrase list of the candidate product group information of the suppliers; and
an information selecting sub-module that selects a preset number of product group information, according to a descending order of the first text similarity degree and the second text similarity degree, from the candidate product group information.

19. One or more computer storage media including processor-executable instructions that, when executed by one or more processors, direct the one or more processors to perform actions comprising:
receiving a search request for one or more suppliers, the search request including one or more search keywords, each of the one or more suppliers having one or more product group information, each product group information having corresponding characteristic weighted parameter, the characteristic weighted parameter including a primary business coefficient;
searching a preset supplier information database to find one or more product group information of the one or more suppliers according to the one or more search keywords;
performing a weighted operation to each of the one or more product group information according to a respective characteristic weighted parameter of the one or more product group information; and
ranking the weighted one or more product group information.

20. One or more computer storage media as recited in claim 19, wherein the actions further comprise returning corresponding supplier information based on a result of the ranking
